(19) United States
(12) Patent Application Publication
(10) Pub. No.: US 2010/0195307 A1
(43) Pub. Date: Aug. 5, 2010

(54) Phosphor Composite Coated Diffuser device and method

(76) Inventor: Klaus Bollmann, Horseshoe Bay, TX (US)

Correspondence Address: RICK B. YEAGER, ATTORNEY, 10805 MELLOW LANE, AUSTIN, TX, 78759, US

(21) Appl. No.: 12/698,588

(22) Filed: Feb. 2, 2010

Related U.S. Application Data
(60) Provisional application No. 61/149,706, filed on Feb. 4, 2009.

(51) Int. Cl. F21V 9/16

(52) U.S. Cl. 362/84

(57) ABSTRACT

A two part device and method for converting a single wavelength light source such as blue LEDs to white light. A separable diffuser light converter is provided in proximity to a directional light source such as plurality of blue LEDs provided on a printed circuit board substrate. In a planar example, red and green phosphors are provided in a polymer, silicon rubber, or epoxy carrier which is applied to the inner surface of a glass or acrylic diffuser. The diffuser is a transparent or translucent material such as glass, acrylic, polycarbonate, or ceramic. The diffuser is removably supported in proximity to the light source. The diffuser light converter may be selected for its phosphor properties, and may be replaced as the diffuser material or phosphor layer degrades.

### RELATED APPLICATIONS

This application is related to U.S. Provisional Patent Application No. 61/149,706 filed by inventor Klaus Bollmann on Feb. 2, 2009, and claims the priority date of that application.

### BACKGROUND

1. Field of Invention

The current invention relates to LED light sources, and more particularly to a diffuser device and method for converting a single wavelength light source to white light.

2. Prior Art

Most prior art white LEDs are using three colored LEDs (red, green and blue) and a mixer lens to produce white perceived light. However this way of producing white light has significant practical downsides for light emitters that have to be viewed from different angles as the light of different wave length refracts differently depending of the viewing angle due to the prismatic effect of the lens. Thus, it is possible to see the composition of the light, meaning at some angles one can see the green, the blue or the red color lasing source in dominance or exclusively rather than a white light source.

There is a need for improved LED light sources which provide a white perceived light from different viewing angles.

The prior art includes references that teach creating inseparable light emitting structures of LEDs and phosphors such as by encapsulating one or more die with a phosphor-loaded lens; depositing a phosphor layer over an LED; or applying a phosphor thin film to an LED to make an integrated device.

### SUMMARY OF INVENTION

The present invention is for a two part device and method for combining a single wavelength light source with a separable diffuser light converter.

Single Wavelength Light Source

In one embodiment, the single wavelength light source is a plurality of blue LEDs, which are currently the highest energy LED which are available. The photo emitter can be excited by normal blue LEDs on either a Printed Circuit Board or another substrate where the LEDs are bonded to each other partially in series and in parallel.

In the future, the single wavelength light source may be green, orange, red or any other color.

In one embodiment, a plurality of blue LEDs are provided on a substrate such as a printed circuit board. Other examples of substrates include a wafer or portion of a wafer.

Separable Diffuser Light Converter

In the current invention, a phosphor-containing element is provided, and is removably affixed to or held in proximity to the single wavelength light source. In one example, a mechanical clamp or superstructure holds the diffuser light converter in position relative to the single wavelength light source. The diffuser light converter is not permanently attached to the light source.

Advantages of Separable Light Source and Diffuser Light Converter

The advantages of a device where the phosphor is carried by a diffuser and is separate from the light source such as LEDs include:

The same light source module can be used to achieve different types of color rendering depending on the phosphor diffuser. This permits higher production volumes of the same light source component with lower complexity resulting in higher yield and quality.

The color temperature can be changed depending on application requirements at any time. Prior art technology applies the phosphor(s) carefully mixed to a light source so that it forms a module with the light source. This fixed combination results in lower yield of consistent wavelength distribution over a production run.

Phosphor coated diffuser modules of a particular type of color rendering performance can be manufactured and selected with higher precision. Variations can be categorized and put into bins.

Diffuser and Phosphor Carrier Module with the precise performance parameters defined by its bin can be selected prior to applying the phosphor diffuser or lens module to the light source.

The light source may have an almost unlimited life, or a life much longer than the phosphor or diffuser. The phosphor in the diffuser may react with the environment and deteriorate; or the diffuser material may be made from acrylic and may deteriorate due to UV exposure. Being able to just replace the diffuser will lower the cost of refurbishing the white light source.

The diffuser may be be glass, acrylic, polycarbonate, ceramic or any other form of sufficiently rigid transparent or translucent material. The opposite surface of the carrier can be a lens, prism, multiple lenses, etched, sand blast or other surface.

### DESCRIPTION OF FIGURES

FIG. 1 is a cross sectional side view of an embodiment of the current invention which shows a plurality of surface mounted LEDs mounted on a substrate; a phosphor layer which has red and green phosphor embedded in a carrier which is affixed or deposited to the inside surface of a cover plate.

FIG. 2 is a cross sectional side view of an embodiment of the current invention which shows a single wavelength light source comprising a plurality of surface mounted LEDs mounted on a substrate; and a diffuser light converter comprising a phosphor layer embedded in a carrier affixed or deposited to the inside surface of a cover plate.

### DESCRIPTION OF EMBODIMENT

### Surface Mounted Blue LEDs with Red and Green Phosphors Provided in Planar Carrier

In this embodiment, white light is produced by using a single wavelength source of photons of the highest energy per watt directional light source such as a laser diode; and creating other wave lengths by using a removable layer of one or more phosphors to achieve a light output of multiple wavelength in the visible spectrum.

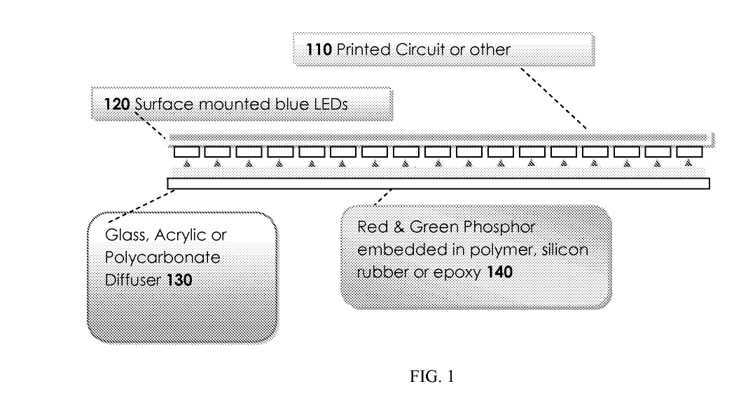

FIG. 1 is a cross sectional side view of an embodiment of the current invention which shows a plurality of surface mounted blue LEDs 120 mounted on a substrate 110 such as a printed circuit board; a phosphor layer 140 which has red and green phosphor embedded in a carrier such as a polymeric material, silicon rubber, or epoxy; where the carrier is affixed or deposited to the inside surface of a cover plate 130 such as glass, acrylic, or polycarbonate.

In this embodiment, at least one layer of red and green phosphors are embedded in a carrier such as polymer, silicon rubber, or epoxy, and that layer is affixed to the inside surface 132 of a diffuser. The outside layer 134 of the diffuser may have features to promote light diffusion.

The light source is not limited but not limited to a particular type of energy to light converter, such as blue LEDs.

To elongate the life of the phosphor, the phosphor is typically protected with a non reactive transparent or translucent compound. In some cases the same compound can be used for adhesion to a low iron glass or other transparent or diffusing carrier.

In large displays requiring back lighting, it is often difficult to achieve even lighting with fluorescent tubes or other reflector based systems.

With the advent of LED technology, pushing the efficiency higher and higher, it will be possible to use conventional high power blue LEDs of a single wavelength to shine at short distance onto a translucent green and red phosphor composite material such as transparent silicone rubber or polymers with embedded phosphor.

One aspect of the current invention is to separate the light emitter from the diffuser and phosphor so that the light source can be mass produced while the light converter can be added at a later stage.

This way it is conceivable to also use other techniques to change wavelength in a diffuser that can be added to a single or multiple wavelength source in the future.

### Single or Multiple Wavelength Emitter(s)

The current invention is not limited to LED (Solid State Lighting) but also applies to any form of single or multiple wavelength emitter(s) that requires one or more wavelength conversions to produce another form of perceived light by either converting one wavelength to another or a combination of being translucent to some of the original wavelength and converting into a different wavelength for the remainder of the light in conjunction with the properties being added to the diffuser or the diffuser being used as the substrate for the filtering and/or converting particles in such a way that it is not permanently affixed to the light emitter and can be added to the light emitter at a later stage, changed to a different performing diffuser.

As better phosphors are developed, a light source can be upgraded by simply changing the phosphor portion of the arrangement.

In this specification, the term “energy to light converter” means LEDs and any form of single or multiple wavelength emitter(s) that requires one or more wavelength conversions to produce another form of perceived light.

The term “LED” refers to light source components which include one or more light emitting diode.
One example of a directional light source is a single laser diode or LED. Another example of a directional light source is a plurality of laser diodes or LEDs mounted on a substrate such as a printed circuit board.
In this specification, the term “substrate” refers to a planar or non-planar support surface for one or more laser diodes or LEDs. Examples of substrates include planar or non-planar printed circuit boards; and wafers or portions of wafers.

### Surface Mounted Blue LEDs with Orange, Red and Green Phosphor Provided in Planar Carrier

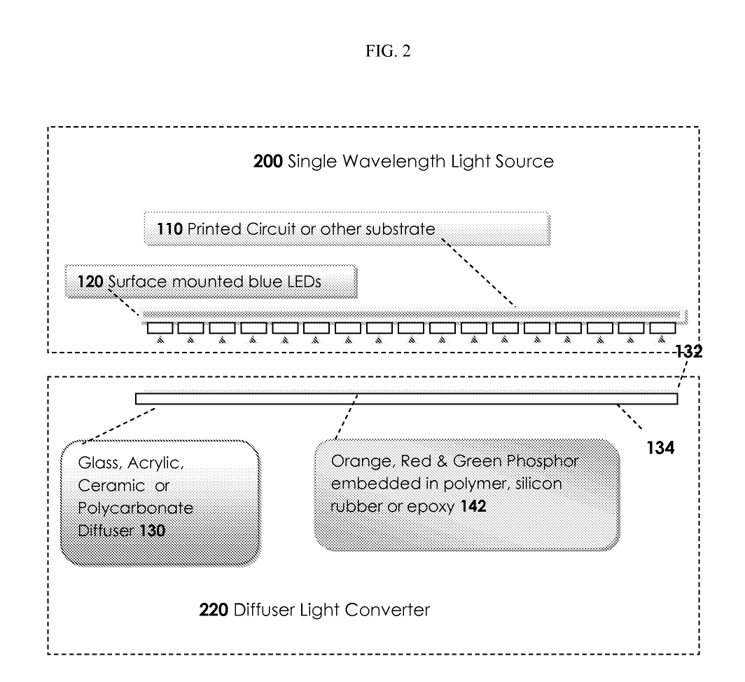

FIG. 2 is a cross sectional side view of an embodiment of the current invention which shows a single wavelength light source 200 comprising a plurality of surface mounted blue LEDs 120 mounted on a substrate 110 such as a printed circuit board; and a diffuser light converter 220 comprising a phosphor layer 142 which has orange, red, and green phosphor embedded in a carrier affixed or deposited to the inside surface of a cover plate 130 such as glass, acrylic, or polycarbonate.

In this example, the phosphor layer has orange, red, and green phosphor embedded in a carrier.

### Non-Planar Diffusers

The current invention is not limited to planar surfaces for the light emitter as it is perfectly conceivable to produce an LED light emitter of one wavelength as a round structure in which case the carrier for the phosphor can be a round structure.

Using this technique odd shaped light emitters with very high efficiency can be achieved by placing lasers at greater distance from each other in a shaped pattern then applying a larger or shaped phosphor carrier.

### Selection of Phosphor Zones

The carrier could also have zones of different mixes of phosphor and allow automatic selection of zones exposed to the single wavelength source allowing to change the color temperature of the arrangement in an application.

The embodiments and examples described above illustrate a few of the devices, systems, and methods which can be implemented in accordance with the present invention. The scope of the claims is not limited to these specific examples.

What is claimed is:

1. A white light source comprising
a directional light source;
a separable diffuser light converter removably held in proximity to the directional light source, the diffuser light converter comprising
a diffuser having an inside surface and an outside surface, and
a first layer of phosphor provided on the inside surface of the diffuser, such that the first layer of phosphor is positioned between the directional light source and the diffuser.

2. The white light source of claim 1 wherein the directional light source is a single wavelength light source.

3. The white light source of claim 2 wherein the single wavelength light source is a plurality of blue LEDs provided on a substrate.

4. The white light source of claim 3 wherein the substrate is a printed circuit board.

5. The white light source of claim 1 wherein the single wavelength light source is at least one green, orange, or red LED.

6. The white light source of claim 1 wherein first layer of phosphor comprises red and green phosphors.

7. The white light source of claim 6 wherein the first layer of phosphor comprises red and green phosphors embedded in a carrier which is affixed or deposited on the inside surface of the diffuser.

8. The white light source of claim 1 wherein the diffuser is non-planar.

9. The white light source of claim 1 further comprising a second layer of phosphor provided on the inside surface of the diffuser.

10. A method of producing white light, the method comprising
providing a directional light source;
providing a separable diffuser light converter comprising
an inside surface,
an outside surface, and
a first layer of phosphor affixed to or deposited on the inside layer;
removably holding the separable diffuser light converter in proximity to the directional light source such that the first layer of phosphor is positioned between the directional light source and the diffuser light converter;
generating a single or multiple wavelength light emission with the directional light source; and
converting a portion of the single or multiple wavelength light emission to a different wavelength with the first phosphor layer.

11. The method of claim 10 wherein providing a directional light source further comprises
providing a plurality of laser diodes having the same emission characteristics.

12. The method of claim 11 wherein providing at least on laser diode further comprises
providing a plurality of blue laser diodes.

13. The method of claim 12 wherein providing a plurality of blue laser diodes further comprises
providing a plurality of blue-emitting laser diodes as surface mount devices on a printed circuit board.

14. The method of claim 10 wherein providing a directional light source further comprises
providing multiple wavelength emitters that require one or more wavelength conversions to produce another form of perceived light.

15. The method of claim 10 wherein providing a diffuser further comprises
providing an outside surface selected from the group consisting of a lens, a prism, multiple lenses, etched surface, and sand blasted surface.

16. The method of claim 10 wherein providing a separable diffuser light converter comprising a first layer of phosphor affixed to or deposited on the inside layer further comprises
providing at least one phosphor in a carrier; and
applying the carrier to the inside surface of the diffuser.

17. The method of claim 16 wherein
providing at least one phosphor in a carrier further comprises providing a red phosphor and a green phosphor in a carrier selected from the group consisting of polymer, silicon rubber, and epoxy.

18. The method of claim 10 wherein providing a separable diffuser light converter comprising a first layer of phosphor affixed to or deposited on the inside layer further comprises
providing at least one phosphor in a first carrier film; and
applying the first carrier film to the inside surface of the diffuser.

19. The method of claim 18 wherein providing a separable diffuser light converter comprising a first layer of phosphor affixed to or deposited on the inside layer further comprises
providing at least one phosphor in a second carrier film; and
applying the second carrier film to the first carrier film.

20. The method of claim 10 wherein providing a separable diffuser light converter further comprises
selecting a diffuser light converter from a plurality of diffuser light converter based on specific properties of the first phosphor layer.
